(19) United States
(12) Patent Application Publication
(10) Pub. No.: US 2026/0154873 A1
(43) Pub. Date: Jun. 4, 2026

(54) IMAGE EDITING USING MACHINE LEARNING MODELS

(71) Applicant: Snap Inc., Santa Monica, CA (US)

(72) Inventors: Erli Ding, Santa Monica, CA (US); Zhixin Lai, Los Angeles, CA (US); Dhritiman Sagar, New York, NY (US)

(21) Appl. No.: 18/966,804

(22) Filed: Dec. 3, 2024

(51) Int. Cl. G06T 11/60; G06V 10/774

(52) U.S. Cl. CPC G06T 11/60; G06V 10/774

(57) ABSTRACT

The present disclosure seeks to address technical problems arising in the field of artificial intelligence (AI) by providing for training of a machine learning model to generate modified images based on an input image and an input instruction. For example, the machine learning model is trained to generate a modified portrait image based on an input portrait image and an input instruction. The machine learning model generates the modified portrait image to depict the input portrait image as modified according to the input instruction while maintaining the identity of a subject depicted in the input portrait image.

### TECHNICAL FIELD

The present disclosure relates to digital image editing. In particular, the present disclosure relates to generating edited digital images using machine learning techniques, including training a machine learning model to generate edited portraits while preserving identity.

### BACKGROUND

In the field of artificial intelligence (AI), various machine learning technologies have been developed to perform various functions of varying complexity, such as classification, computer vision, and natural language processing. However, as machine learning models are tasked with performing more complex functions, these machine learning models face greater technological challenges with respect to, for example, feature preservation, instruction fidelity, and inference speed. For example, machine learning models tasked with complex functions, such as image editing, may be unable to do so efficiently and correctly. As a result, these machine learning models face technical problems with respect to performing complex functions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a machine learning pipeline, according to some examples.

FIG. 4 is a diagrammatic representation of training and use of a machine learning program, according to some examples.

FIG. 5 is a diagrammatic representation of generating training data, according to some examples.

FIG. 6 is a diagrammatic representation of training a machine learning model, according to some examples.

FIG. 7 is a diagrammatic representation of training a machine learning model, according to some examples.

FIG. 8 is a diagrammatic representation of a loss function, according to some examples.

FIG. 9 is a diagrammatic representation of a method, according to some examples.

FIG. 10 is a diagrammatic representation of a data structure as maintained in a database, according to some examples.

FIG. 11 is a diagrammatic representation of a message, according to some examples.

FIG. 12 is a diagrammatic representation of a machine in the form of a computer system within which a set of instructions may be executed to cause the machine to perform any one or more of the methods discussed herein, according to some examples.

FIG. 13 is a block diagram showing a software architecture within which examples may be implemented.

### DETAILED DESCRIPTION

As machine learning models are tasked with performing increasingly complex functions, new technical challenges arise that impede the performance of these increasingly complex functions. For example, machine learning models tasked with complex functions, such as editing or manipulating images, face technical challenges with respect to feature preservation, instruction fidelity, and inference speed, that do not arise when the machine learning models are tasked with relatively less complex functions. Indeed, a failure to preserve features while editing an image may result in the edited image appearing to be completely different rather than appearing to be edited. A failure to maintain fidelity to instructions while editing an image may result in the edited image being incorrectly edited. Furthermore, attempting to preserve features and attempting to maintain fidelity when editing an image may introduce various inefficiencies that reduce inference speed. These technical challenges are exacerbated with respect to certain functions, such as editing a portrait image, because preserving the identity of the person depicted in the portrait image is both highly important and technically challenging. Thus, machine learning models face technical problems with respect to feature preservation, instruction fidelity, and inference speed.

The present disclosure seeks to address these and other technical problems arising in the field of artificial intelligence (AI). As an overview of some examples, the present disclosure provides for training a machine learning model to generate modified images based on an input image and an input instruction. For example, the machine learning model is trained to generate a modified portrait image based on an input portrait image and an input instruction for modifying the input portrait image. The machine learning model generates the modified portrait image to depict the input portrait image as modified according to the input instruction while maintaining the identity of a subject (e.g., person) depicted in the input portrait image.

In some examples, training the machine learning model to generate modified portrait images involves generating a training data set. For example, a training data set for training the machine learning model to generate modified portrait images includes training image pairs of input portrait images and target portrait images. To generate this training data set, the target portrait images are generated first using target prompts, which are prompts combining identity prompts and instruction prompts. An identity prompt provides features related to the identity of a person (e.g., age, gender, skin tone, facial features). An instruction prompt provides features related to modifying an image (e.g., style, makeup, hair style, clothing, accessories, background). Target prompts are provided to a first image generation model to generate the target portrait images. The target portrait images and the identity prompts are provided to a second image generation model to generate the input portrait images. In some examples, using the second image generation model to generate the input portrait images based on the target portrait images provides input portrait images that are of a lower image quality than the target portrait images. Using training image pairs of lower image quality input portrait images and target portrait images provides a technical benefit of training the machine learning model to generate target portrait images of a higher image quality based on an input portrait image, improving feature preservation and instruction fidelity.

In some examples, training the machine learning model to generate modified portrait images involves a first stage in which a first machine learning model (e.g., teacher model, identity enhancement network) is trained to learn identity preserving features. The first machine learning model generates an output portrait image based on an input portrait image from the training data set. The first machine learning model is trained to minimize a loss function between the output portrait image and a target portrait image from the training data set corresponding with the input portrait image. In some examples, the loss function is an annealing identity loss function that emphasizes identity preserving features in early timesteps of the image generation process and gradually transitions to emphasizing style enhancing features in later timesteps of the image generation process. The identity preserving features learned by the first machine learning model are learned by subsequently trained machine learning models, improving the feature preservation abilities of these machine learning models.

In some examples, training the machine learning model to generate modified portrait images involves a second stage in which a second machine learning model (e.g., student model, instant portrait network) is trained to apply style to an input portrait image while preserving identity features. The second machine learning model generates an output portrait image based on an input portrait image from the training data set. The second machine learning model is trained to minimize one or more loss functions. For example, the second machine learning model is trained to minimize a first loss function between the output portrait image generated by the second machine learning model and the output portrait image generated by the first machine learning model for the input portrait image. The first loss function is a distillation loss function that facilitates training the second machine learning model to learn the identity preserving features learned by the first machine learning model. The second machine learning model is further trained to minimize a second loss function between the output portrait image generated by the second machine learning model and the target portrait image from the training data set corresponding with the input portrait image. The second loss function is an adversarial loss function that facilitates training the second machine learning model to generate modified portrait images efficiently (e.g., one-shot generation). The second machine learning model is further trained to minimize a third loss function based on relationships between the input portrait image, the output portrait image, and the target portrait image. The third loss function is a triplet loss function that balances identity preservation with style variation. Training a machine learning model using these loss functions improves the feature preservation, instruction fidelity, and inference speed of the machine learning model. Further details related to the aforementioned technical solutions are provided herein.

### Networked Computing Environment

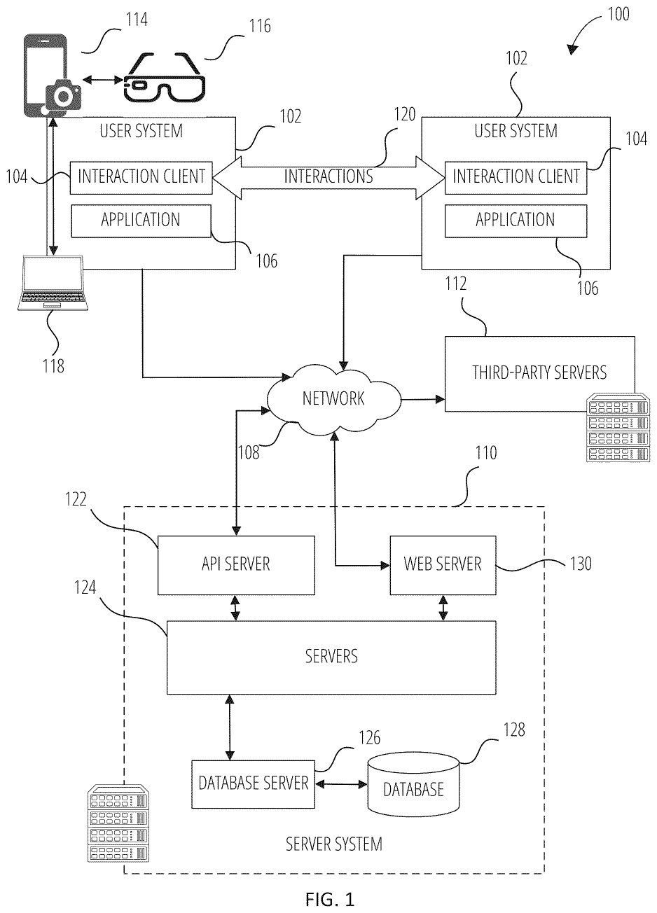

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 1008); the location of friends within an entity relationship graph; and opening an application event (e.g., relating to the interaction client 104).

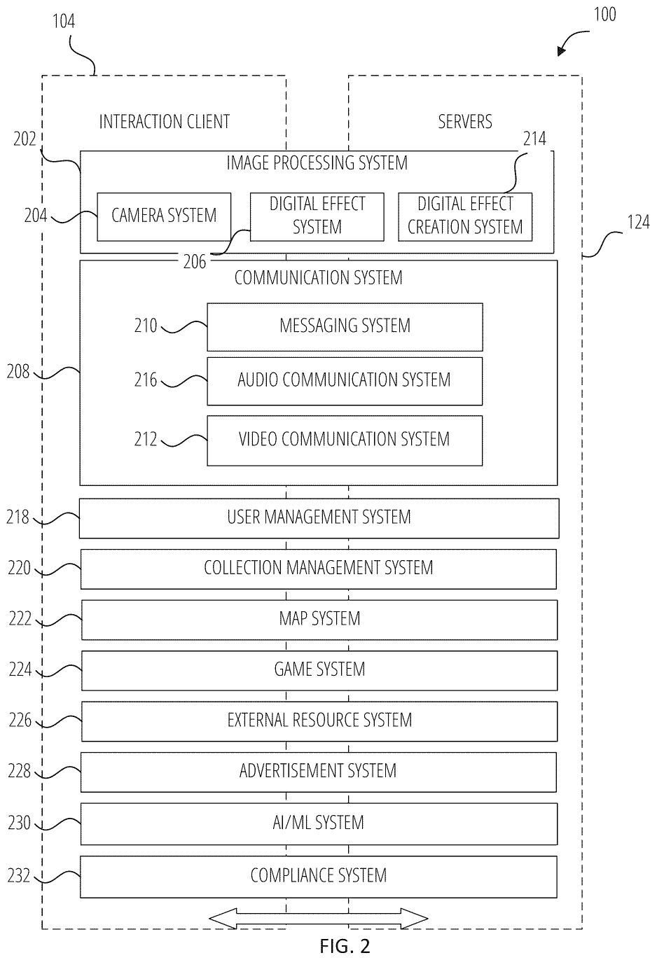

The servers 124 host multiple systems and subsystems, described below with reference to FIG. 2.

### External Recourses and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 1006, entity graphs 1008 and profile data 1002) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 1002) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. For example, the artificial intelligence and machine learning system 230 can generate modified images based on an input image and an input instruction. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Machine Learning Pipeline

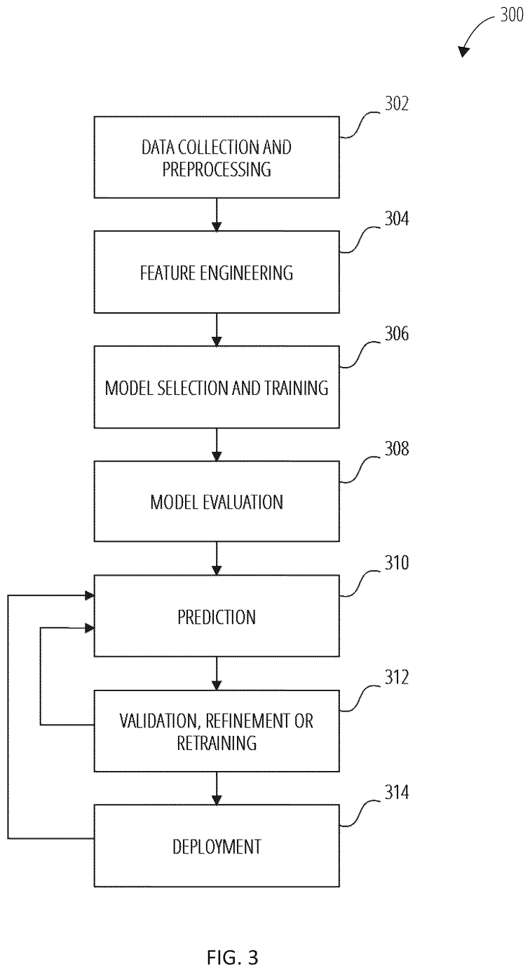

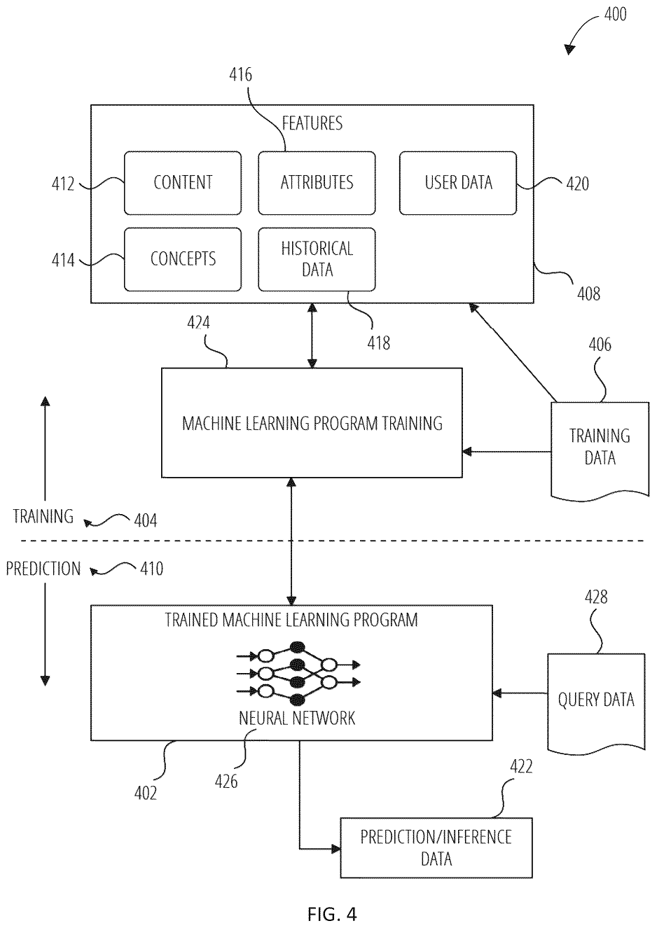

FIG. 3 is a flowchart 300 illustrating a machine learning pipeline, according to some examples. The machine learning pipeline may be used to generate a trained model such as, for example, the trained machine learning program 402 shown in the block diagram 400 of FIG. 4.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as Convolutional Neural Networks (CNNs), Recurrent Neural Networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data. Although several specific examples of machine learning algorithms are discussed herein, the principles discussed herein can, where possible or relevant, be applied to other machine learning algorithms as well. Deep learning algorithms such as CNNs, RNNs, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 402 may include multiple phases that form part of the machine learning pipeline, including, for example, the following phases illustrated in FIG. 3:
Data collection and preprocessing 302: This phase may include acquiring and cleaning data to ensure that it is suitable for use in the machine learning model. This phase may also include removing duplicates, handling missing values, and converting data into a suitable format.
Feature engineering 304: This phase may include selecting and transforming the training data 406 to create features that are useful for predicting the target variable. Feature engineering may include (1) receiving features 408 (e.g., as structured or labeled data in supervised learning) and/or (2) identifying features 408 (e.g., unstructured, or unlabeled data for unsupervised learning) in training data 406.
Model selection and training 306: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 308: This phase may include evaluating the performance of a trained model (e.g., the trained machine learning program 402) on a separate testing dataset. This phase can help determine if the model is overfitting or underfitting and determine whether the model is suitable for deployment.
Prediction 310: This phase involves using a trained model (e.g., trained machine learning program 402) to generate predictions on new, unseen data.
Validation, refinement, or retraining 312: This phase may include updating a model based on feedback generated from the prediction phase, such as new data or user feedback.
Deployment 314: This phase may include integrating the trained model (e.g., the trained machine learning program 402) into a more extensive system or application, such as a web service, mobile app, or Internet of Things (IoT) device. This phase can involve setting up APIs, building a user interface, and ensuring that the model is scalable and can handle large volumes of data.

FIG. 4 is a block diagram 400 illustrating further details of two example phases, namely a training phase 404 (e.g., part of model selection and training 306) and a prediction phase 410 (part of prediction 310). Prior to the training phase 404, feature engineering 304 is used to identify features 408. This may include identifying informative, discriminating, and independent features for effectively operating the trained machine learning program 402 in pattern recognition, classification, and regression. In some examples, the training data 406 includes labeled data, known for pre-identified features 408 and one or more outcomes. Each of the features 408 may be a variable or attribute, such as an individual measurable property of a process, article, system, or phenomenon represented by a data set (e.g., the training data 406). Features 408 may also be of different types, such as numeric features, strings, and graphs, and may include one or more of content 412, concepts 414, attributes 416, historical data 418, and/or user data 420, merely for example.

In training phase 404, the machine learning program may use the training data 406 to find correlations among the features 408 that affect a predicted outcome or prediction/inference data 422. With the training data 406 and the identified features 408, the trained machine learning program 402 is trained during the training phase 404 during machine learning program training 424. The machine learning program training 424 appraises values of the features 408 as they correlate to the training data 406. The result of the training is the trained machine learning program 402 (e.g., a trained or learned model).

Further, the training phase 404 may involve machine learning, in which the training data 406 is structured (e.g., labeled during preprocessing operations). The trained machine learning program 402 may implement a neural network 426 capable of performing, for example, classification or clustering operations. In other examples, the training phase 404 may involve deep learning, in which the training data 406 is unstructured, and the trained machine learning program 402 implements a neural network 426 that can perform both feature extraction and classification/clustering operations.

In some examples, a neural network 426 may be generated during the training phase 404 and implemented within the trained machine learning program 402. The neural network 426 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 426 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 426 may also be one of several different types of neural networks, such as a single-layer feed-forward network, a Multilayer Perceptron (MLP), an Artificial Neural Network (ANN), a RNN, a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 404, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 410, the trained machine learning program 402 uses the features 408 for analyzing query data 428 to generate inferences, outcomes, or predictions, as examples of a prediction/inference data 422. For example, during prediction phase 410, the trained machine learning program 402 generates an output. Query data 428 is provided as an input to the trained machine learning program 402, and the trained machine learning program 402 generates the prediction/inference data 422 as output, responsive to receipt of the query data 428.

In some examples, the trained machine learning program 402 may be a generative AI model. Generative AI is a term that may refer to any type of AI that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
VAEs: VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.
Diffusion models, as described below.

In generative AI examples, the prediction/inference data 422 may include predictions, translations, summaries, answers, media content, or combinations thereof.

A diffusion model is a type of generative machine learning model that can be used to generate images or videos from a given input (e.g., text prompt, input image). It is based on the concept of “diffusing” noise throughout an image to transform it gradually into a new image. A diffusion model may use a sequence of invertible transformations to transform a random noise image into a final image. During training, a diffusion model may learn sequences of transformations that can best transform random noise into desired output. A diffusion model can be fed with input data (e.g., a text describing the desired images and the corresponding output images, an input image and corresponding output videos), and the parameters of the model are adjusted iteratively to improve its ability to generate accurate or good quality images.

Once trained, in order to generate an image, the diffusion model applies a trained sequence of transformations to an input to generate an output image. The model generates the image in a step-by-step manner, updating the image sequentially with additional information until the image is fully generated. In some examples, this process may be repeated to produce a set of candidate images, from which the final image is chosen based on criteria such as a likelihood score. The resulting image may be intended to represent a visual interpretation of a text prompt.

### Portrait Image Editing Using Machine Learning

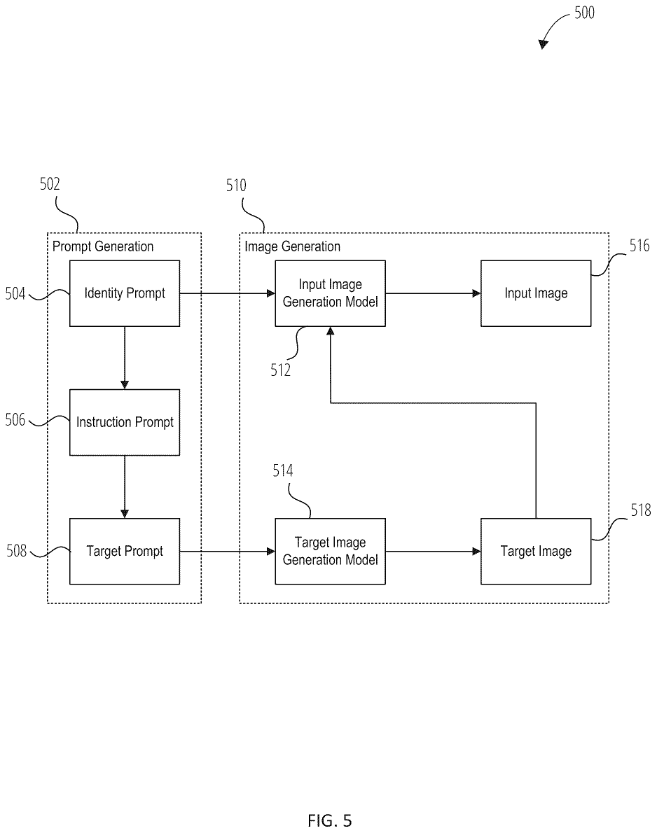

FIG. 5 is a block diagram 500 illustrating a machine learning pipeline for generating a training data set, according to some examples. As illustrated in the block diagram 500, generating the training data set includes prompt generation 502 and image generation 510. Prompt generation 502 includes generating an identity prompt 504, generating an instruction prompt 506, and generating a target prompt 508. In some examples, the identity prompt 504, the instruction prompt 506, and the target prompt 508 are generated based on one or more large language models. Image generation 510 includes an input image generation model 512 for generating an input image 516 and a target image generation model 514 for generating a target image 518. In some examples, the input image 516 and the target image 518 form a training image pair for training a machine learning model.

In prompt generation 502, the identity prompt 504 specifies identity features describing human attributes, such as age, gender, nationality, skin tone, and facial features, of a subject (e.g., person) for image generation. These identity features represent characteristics that facilitate identity preservation when an image is modified. Maintaining the identity features between an image and a modified image allows for an identity of a subject depicted in the image and the modified image to be preserved. For example, the identity prompt 504 may include the phrase “a young Chinese woman” to identify features (e.g., “young,” “Chinese,” “woman”) that, if modified in a portrait image, would likely alter the identity of the person depicted in the portrait image.

The instruction prompt 506 specifies modification features describing modifications, such as style, makeup, hair, clothing, accessories, and background elements for a subject (e.g., person) for image modification. These modification features represent elements that may be modified in an image while preserving the identity of the subject in the image. Modifying these elements in an image to produce a modified image while maintaining identity features between the image and the modified image allows for the modified image to depict a variety of styles and appearances while preserving the identity of the subject depicted in the image and the modified image. For example, the instruction prompt 506 may include the phrase “with long hair, wearing pale red lipstick, in Egyptian style, in front of a museum” to identify features (e.g., “long hair,” “pale red lipstick,” “Egyptian style,” “museum”) that may be modified in a portrait image while maintaining the identity of the person depicted in the portrait image.

The target prompt 508 combines the identity prompt 504 and the instruction prompt 506 to create a complete description of a subject (e.g., person) for image generation. The complete description integrates the identity features of the identity prompt 504 with the modification features of the instruction prompt 506 to provide an input to an image generation model for generating a modified image. For example, the target prompt 508 may include the phrase “a young Chinese woman, with long hair, wearing pale red lipstick, in Egyptian style, in front of a museum” to combine identity features (e.g., “young,” “Chinese,” “woman”) and modification features (e.g., “long hair,” “pale red lipstick,” “Egyptian style,” “museum”) for generating a modified portrait image. In some examples, a set of input prompts and a set of instruction prompts are generated by a large language model, and a set of target prompts is generated based on the set of input prompts and the set of instruction prompts. The set of target prompts is generated, for example, by combining input prompts from the set of input prompts with instruction prompts from the set of instruction prompts.

In image generation 510, the target image generation model 514 generates the target image 518 based on the target prompt 508. In some examples, the target image generation model 514 is a text-to-image generation model (e.g., Stable Diffusion model, Stable Diffusion XL model). The target image generation model 514 generates the target image 518 without additional control inputs or adapters to promote fidelity between the target image 518 and the target prompt 508. This also promotes high quality image generation by the target image generation model 514.

The input image generation model 512 generates the input image 516 based on the identity prompt 504 and the target image 518. In some examples, the input image generation model 512 is a text-to-image generation model incorporating control mechanisms to facilitate receiving the target image 518 as an input and generating the input image 516 to be consistent with the target image 518. For example, the input image generation model 512 includes an image prompt adapter (e.g., IP-Adapter) that enables image prompt capabilities in the text-to-image generation model. This allows the input image generation model 512 to accept the target image 518 as an input. The input image generation model 512 includes a control network (e.g., ControlNet) that extracts and processes edge information from the target image 518. Using the edge information from the target image 518, the input image generation model 512 generates the input image 516 with pose characteristics and structural features consistent with those of the target image 518. Using the identity features of the identity prompt 504, which are the same identity features of the target prompt 508 from which the target image 518 is generated, the input image generation model 512 generates the input image 516 with human attributes that are the same as those of the target image 518.

In some examples, because the input image generation model 512 generates the input image 516 based on the target image 518 while incorporating various control mechanisms to maintain identity features between the input image 516 and the target image 518, the input image generation model 512 generates the input image 516 at a lower image quality than the target image 518. This advantageously allows a machine learning model to be trained to generate images of a higher image quality based on input images of a lower image quality.

Based on the machine learning pipeline a set of training data is generated for training a machine learning model to generate modified portrait images while preserving identity. The set of training data includes training instances of training image pairs comprising input images and target images. The training instances include the instruction prompts used in generating the training image pairs. A machine learning model is trained, based on the set of training data, to generate target images based on input images and instruction prompts, as further described herein.

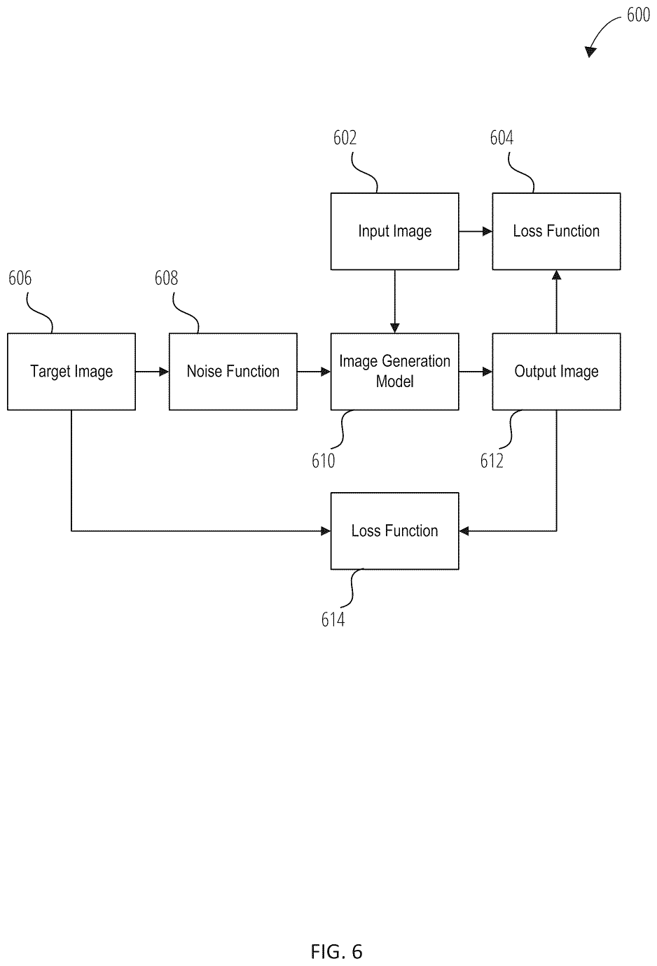

FIG. 6 is a block diagram 600 illustrating a machine learning pipeline for training an image generation model 610, according to some examples. In some examples, the image generation model 610 is a machine learning model (e.g., identity enhancement network) trained to generate an output image based on an input image while maintaining identity preserving features between the input image and the output image. In some examples, the image generation model 610 is a first machine learning model used to train (e.g., as a teacher model) a second machine learning model to generate, based on an image, a modified image that applies style while preserving identity.

In training the image generation model 610, a target image 606 is processed through a noise function 608 and provided to the image generation model 610. The noise function 608 adds incremental noise to the target image 606 based on, for example, a fixed noise scaling factor, sampling noise from a standard normal distribution. The image generation model 610 generates an output image 612 based on an input image 602, the target image 606, and an instruction prompt. The image generation model 610 is trained to generate the output image 612 with style modifications based on the instruction prompt while maintaining the identity of a subject (e.g., person) in the input image 602. To facilitate this training, the image generation model 610 is trained to minimize a first loss function 604 between the input image 602 and the output image 612 and to minimize a second loss function 614 between the output image 612 and the target image 606.

In some examples, the first loss function 604 is an annealing identity loss function that balances identity preservation features with style modification features. The annealing identity loss function balances identity preservation features (e.g., structural features) with style modification features (e.g., color features, texture features) by applying progressively decreasing weights to a constant identity loss function used to penalize losses in identity preservation features. By applying the progressively decreasing weights, the annealing identity loss function emphasizes maintaining identity preservation features in early timesteps of the image generation process and emphasizes style modification features in later timesteps of the image generation process. In some examples, the progressively decreasing weights follow a linear decay function or a cosine decay function. The annealing identity loss function advantageously maintains strong identity preservation features early in the image generation process when structural features are being generated while gradually transitioning to allow more style modifications to be made as the image generation process progresses. This gradual transition further provides improvements to the image generation process by reducing visible artifacts in the generated image while facilitating uniform style modifications over the generated image.

For example, the annealing identity loss function is:

$${ℒ}_{aid} = {W}_{a} ( t , {T}_{max} ) * {ℒ}_{cid}$$

where L_{aid} is an annealing identity loss, Wₐ is an annealing weight that decreases as timesteps decrease, t is a timestep, Tₘₐₓ is a maximum timestep, and L_{cid} is a constant identity loss. An example constant identity loss function is:

$${ℒ}_{cid} = {𝔼}_{\text{?}} [ {‖ {F}_{crop} ( {F}_{\text{?}} ( {c}_{I} ) ) - {F}_{crop} ( {F}_{\text{?}} ( {\hat{x}}_{θ} ) ) ‖}_{2}^{2} ]$$

$$\text{?} \text{indicates text missing or illegible when filed}$$

where L_{cid} is a constant identity loss, E is an expectation (e.g., average) of the L2 distance (represented by the double vertical bars) between the input image (c_{I}) and the output image (x_{θ}), F_{crop} is a crop function, and F_{g} is a grayscale function. In some examples, the crop function is used to crop an image around a facial region in the image. The grayscale function is used to convert a color image to a grayscale image.

In some examples, the second loss function 614 is a diffusion loss function. The diffusion loss function evaluates how well the image generation model 610 predicts noise in a latent space during the image generation (e.g., denoising) process. By comparing the predicted noise of the output image 612 with the actual noise that was added to the target image 606 by the noise function 608, the diffusion loss function emphasizes style modifications consistent with the style modifications made to generate the target image 606.

The image generation model 610 is trained to minimize both the first loss function 604 and the second loss function 614 to learn both identity preserving features and style modification features. To balance identity preservation features with style modification features a total loss function incorporating the first loss function 604 and the second loss function 614 is weighted with a balancing weight that balances between the identity preservation features learned from minimizing the first loss function 604 and the style modification features learned from minimizing the second loss function 614. An example total loss function is:

$${ℒ}_{IDE - Net} = {ℒ}_{dm} + {λ}_{aid} * {ℒ}_{aid}$$

where L_{IDE-Net} is a total loss, L_{dm} is a diffusion loss, λ_{aid} is a balancing weight, and L_{aid} is an annealing identity loss. In some examples, the balancing weight is adjusted to emphasize identity preservation or style modification by increasing the balancing weight to emphasize identity preservation and decreasing the balancing weight to emphasize style modification.

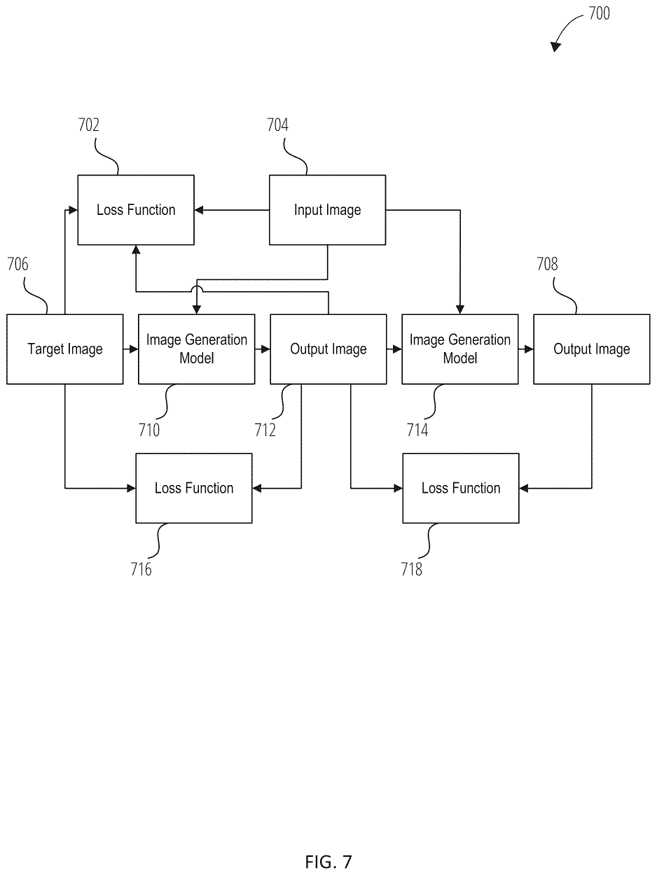

FIG. 7 is a block diagram 700 illustrating a machine learning pipeline for using a first image generation model 714 to train a second image generation model 710, according to some examples. In some examples, the first image generation model 714 is a machine learning model (e.g., identity enhancement network), such as the image generation model 610 of FIG. 6, trained to generate an output image based on an input image while maintaining identity preserving features between the input image and the output image. The first image generation model 714 is used as a teacher model to train the second image generation model 710 to generate output image that apply style to an input image while preserving identity of the input image. In some examples, the second image generation model 710 is trained to apply amplified style modifications relative to the first image generation model 714 while operating with improved efficiency relative to the first image generation model 714.

In training the second image generation model 710, the first image generation model 714 generates a first output image 708 based on an input image 704, a second output image 712 generated by the second image generation model 710, and an instruction prompt. The second image generation model 710 generates the second output image 712 based on the input image 704, a target image 706, and the instruction prompt. In some examples, a noise function is applied to the target image 706 to add incremental noise to the target image 706 prior to the target image 706 being provided to the second image generation model 710. A noise function is applied to the second output image 712 to add incremental noise to the second output image 712 prior to the second output image 712 being provided to the first image generation model 714. Through this training process, the second image generation model 710 is trained to generate the second output image 712 to apply style to the input image 704 while maintaining the identity of a subject (e.g., person) in the input image 704. To facilitate this training, the second image generation model 710 is trained to minimize a first loss function 716 between the second output image 712 and the target image 706 and a second loss function 718 between the second output image 712 and the first output image 708. The training of the second image generation model 710 is balanced with respect to identity preservation and style modification through a third loss function 702 between the input image 704, the target image 706, and the second output image 712. Through the use of multiple loss functions, different objectives including identity preservation, style modification, and operating efficiency are balanced throughout the training process.

In some examples, the first loss function 716 is an adversarial loss function that incorporates a discriminator model trained to distinguish between images generated by the second image generation model 710 (e.g., “fake” images) and target images (e.g., “real” images). The discriminator model is trained using training data that includes target images labeled as “real” images and images generated by the second image generation model 710 labeled as “fake” images. Training the second image generation model 710 to minimize the adversarial loss function involves minimizing the difference between the discriminator model's outputs for images generated by the second image generation model 710 and target images such that the images generated by the second image generation model 710 are identified by the discriminator model as target images. As the second image generation model 710 is trained to minimize the adversarial loss function, the discriminator model is trained based on the images generated by the second image generation model 710 to better distinguish the “fake” images generated by the second image generation model 710 from the “real” target images. By training the discriminator model and the second image generation model 710 in parallel, each model improves the performance of the other model. The adversarial loss function advantageously improves the operating efficiency by which the second image generation model 710 generates images. In some examples, the improved efficiency allows the second image generation model 710 to generate images in a single step or a single pass and allows the second image generation model 710 to operate with fewer layers than, for example, the first image generation model 714.

In some examples, the second loss function 718 is an identity distillation loss function that facilitates the second image generation model 710 learning the identity preservation capabilities of the first image generation model 714 while reducing the number of inference steps. The identity distillation loss function compares the second output image 712 with the first output image 708. In some examples, the first image generation model 714 is trained to generate images while maintaining identity preserving features, for example, as described with respect to the image generation model 610 of FIG. 6. The first image generation model 714 is frozen during the training of the first image generation model 714 to maintain the identity preservation capabilities the first image generation model 714 learned.

In some examples, the identity distillation loss function involves a two-stage approach based on the timestep of the image generation process. For timesteps greater than a timestep threshold (e.g., 200 timesteps), a sampling process (e.g., stochastic sampling with random noise) is used to maintain coarse-grained structural features that facilitate the maintenance of identity preserving features between images. For timesteps less than or equal to the timestep threshold, an inversion process (e.g., Denoising Diffusion Implicit Models (DDIM) inversion) is used to emphasize fine details using predicted noise. This two-stage approach allows for training of the second image generation model 710 to emphasize learning the identity preservation capabilities of the first image generation model 714 during early steps of the image generation process, where a focus on structural features and other identity preserving features is more influential, and to emphasize learning refinement of details and style in later steps of the image generation process, after the identity preserving features have been maintained.

For example, the identity distillation loss function is:

$${ℒ}_{distill} = {𝔼}_{\text{?}} [ {‖ {\hat{x}}_{θ} ( stop\_grad ( {z}_{\text{?}} ) ) - {\hat{x}}_{\text{?}} ‖}_{2}^{2} ]$$

$$\text{?} \text{indicates text missing or illegible when filed}$$

where L_{distill} is an identity distillation loss, E is an expectation (e.g., average) of the L2 distance (represented by the double vertical bars) between the first output image 708 (x_{φ}) and the second output image 712 (x_{θ}), zₜ is a noise sample at timestep t, and stop_grad is a stop-gradient operation that prevents certain parts of the second output image 712 (x_{θ}) from contributing to the loss function calculation. The two-stage approach for the identity distillation loss is implemented through two calculations for zₜ which are:

$${z}_{t} = \{ \begin{matrix}\sqrt{{α}_{t}} {\hat{z}}_{\text{?}} + \sqrt{1 - {α}_{t}} {\hat{ϵ}}_{θ} ( {\hat{z}}_{\text{?}} , t ) & t \leq τ \\ \sqrt{{α}_{t}} {\hat{z}}_{\text{?}} + \sqrt{1 - {α}_{t}} {ϵ}_{t} & t > τ\end{matrix}$$

$$\text{?} \text{indicates text missing or illegible when filed}$$

where zₜ is a noise sample at timestep t, \sqrt{αₜ}\hat{z}_{φ}+\sqrt{1−αₜ}ϵₜ is a stochastic noise function, \sqrt{αₜ}\hat{z}_{φ}+\sqrt{1−αₜ}ϵ_{θ}(\hat{z}_{φ}, t) is a DDIM inversion process that directly predicts the noise sample zₜ and omits stochastic noise, and τ is a timestep threshold.

In some examples, the third loss function is a triplet loss function used to adjust the balance between identity preservation features and style modification features. The triplet loss function evaluates three images, the input image 704, the second output image 712, and the target image 706. In some examples, the triplet loss function evaluates the input image 704, the second output image 712, and the target image 706 based on distances between embeddings corresponding with the input image 704, the second output image 712, and the target image 706. The distances include a first distance between an input image embedding corresponding with the input image 704 and an output image embedding corresponding with the second output image 712. The distances include a second distance between the output image embedding and a target image embedding corresponding with the target image 706. The embeddings are generated, for example, by an embedding model (e.g., self-Distillation with NO labels (DINO) embedding model). For example, the input image 704, the second output image 712, and the target image 706 are cropped around the facial regions and processed through the embedding model to generate corresponding embeddings that reflect the identity features and style features of the cropped images.

The triplet loss function evaluates the first distance and the second distance against a margin parameter that controls the balance between identity preservation and style modification. The second image generation model 710 is trained to minimize the difference between the first distance and the second distance such that the difference is within the margin parameter. For example, the triplet loss function is:

$${ℒ}_{triplet} = Max ( {d}_{2} - {d}_{1} - m , 0 )$$

where Lₜᵣᵢₚₗₑₜ is a triplet loss, d₁ is a first distance between the output image embedding and the input image embedding, d₂ is a second distance between the output image embedding and the target image embedding, m is a margin parameter, and Max is maximum function.

In some examples, the second image generation model 710 is trained to minimize a total loss function based on the adversarial loss function, the identity distillation loss function, and the triplet loss function. For example, a total loss function is:

$${ℒ}_{IPNet} = {ℒ}_{adv} + {λ}_{distill} * {ℒ}_{distill} + {λ}_{triplet} * {ℒ}_{triplet}$$

where L_{IPNet} is a total loss, L_{adv} is an adversarial loss, λ_{distill} is a first balancing weight, L_{distill} is an identity distillation loss, λₜᵣᵢₚₗₑₜ is a second balancing weight, and Lₜᵣᵢₚₗₑₜ is a triplet loss.

In some examples, the second image generation model 710 is used to generate a modified image based on an input image and an input instruction. The second image generation model 710 generates the modified image to depict style modifications based on the input instruction while maintaining an identity of a subject (e.g., person) depicted in the input image. In some examples, the second image generation model 710 is used to iteratively amplify style modifications in a modified image. For example, the modified image generated by the second image generation model 710 is provided as input to the second image generation model 710 with the input instruction used to generate the modified image. Based on the modified image and the input instruction, the second image generation model 710 generates another modified image with amplified style modifications relative to the modified image that was provided as input while maintaining the identity of the subject depicted in the modified image.

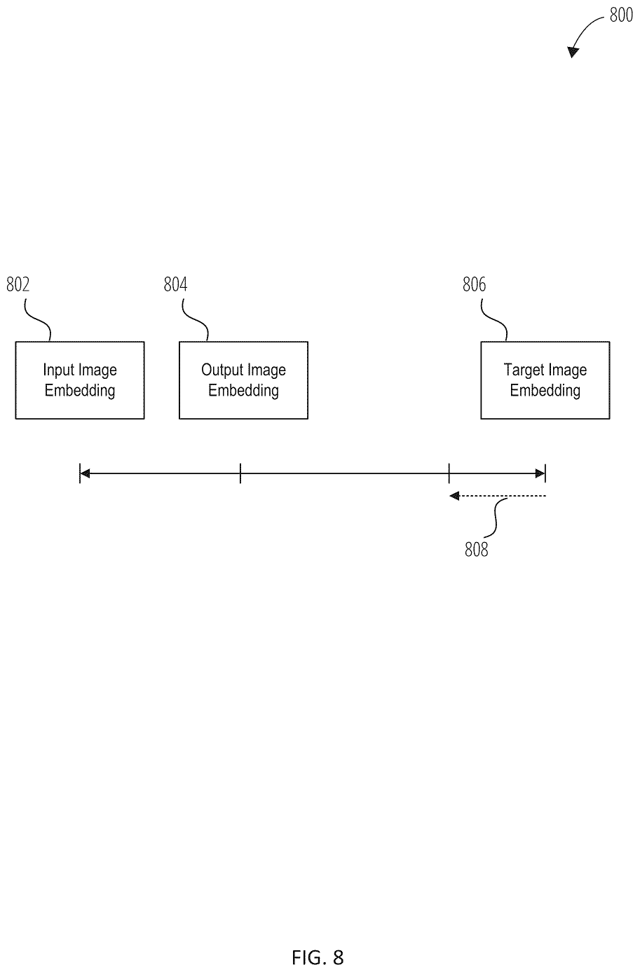

FIG. 8 is a block diagram 800 illustrating a triplet loss function, according to some examples. In the block diagram 800, an input image embedding 802 that corresponds with an input image provided to an image generation model is at a first distance away from an output image embedding 804 that corresponds with an output image generated by the image generation model. The output image embedding is at a second distance away from a target image embedding 806 that corresponds with a target image with which the output image generated by the image generation model is evaluated. A margin parameter 808 serves to reduce the second distance between the output image embedding 804 and the target image embedding 806, bring the second distance and the first distance to equal distances. This effectively serves to skew training of the image generation model towards maintaining identity preservation features by skewing output images generated by the image generation model towards the input images provided to the image generation model. An increase to the margin parameter 808 would further skew the training of the image generation model towards maintaining identity preservation features. A decrease to the margin parameter 808 would skew the training of the image generation model towards style modifications by skewing output images generated by the image generation model towards the target images with which the output images are evaluated. As illustrated here, the triplet loss function advantageously provides control over balancing the training of the image generation model between identity preservation and style modification.

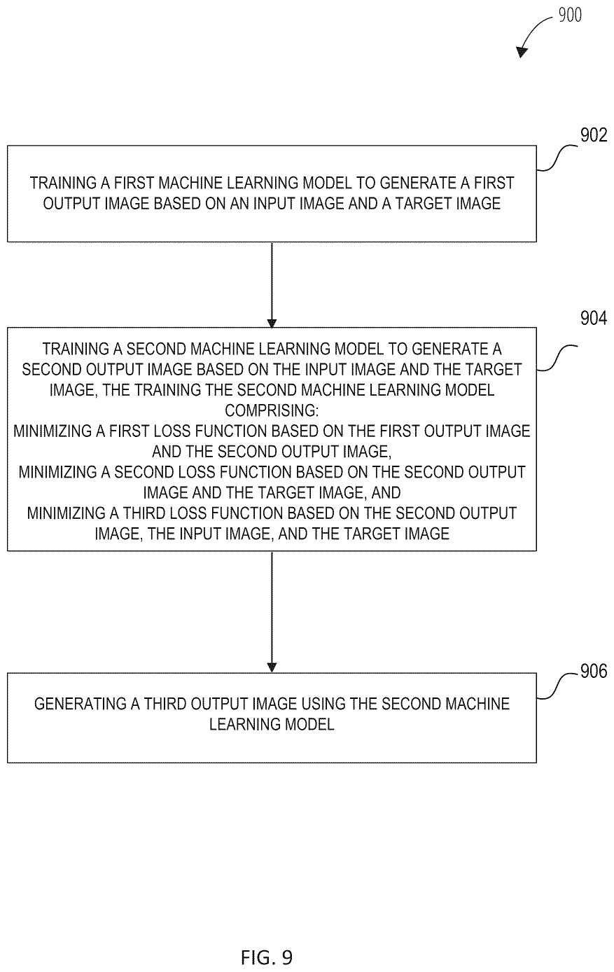

FIG. 9 illustrates an example method 900, according to some examples. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

At operation 902, the example method 900 trains a first machine learning model to generate a first output image based on an input image and a target image. The first machine learning model may be trained, for example, based on the machine learning pipeline described with respect to FIG. 6. At operation 904, the example method 900 trains a second machine learning model to generate a second output image based on the input image and the target image. The second machine learning model may be trained, for example, based on the machine learning pipeline described with respect to FIG. 7. The training of the second machine learning model comprises minimizing a first loss function based on the first output image and the second output image, minimizing a second loss function based on the second output image and the target image, and minimizing a third loss function based on the second output image, the input image, and the target image. At operation 906, the example method 900 generates a third output image using the second machine learning model.

### Data Architecture

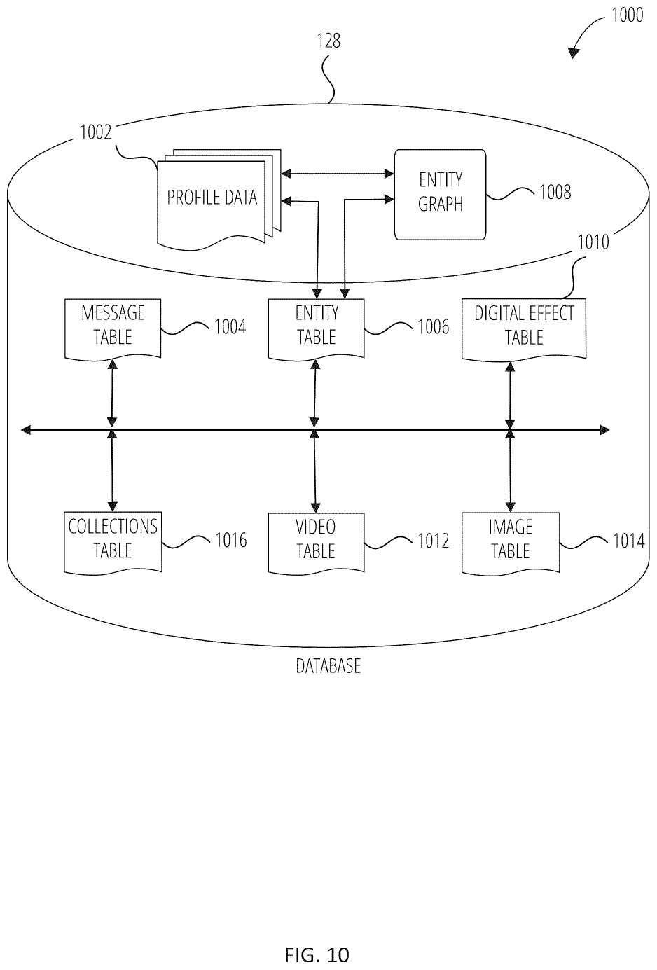

FIG. 10 is a schematic diagram illustrating data structures 1000, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 1004. This message data includes at least message sender data, message recipient (or receiver) data, and a payload. Further details regarding information that may be included in a message and included within the message data stored in the message table 1004, are described below with reference to FIG. 10.

An entity table 1006 stores entity data, and is linked (e.g., referentially) to an entity graph 1008 and profile data 1002. Entities for which records are maintained within the entity table 1006 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 1008 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user and may significantly restrict or block the publication of digital content from the individual user to the commercial user. A particular user, as an example of an entity, may record certain restrictions (e.g., by way of privacy settings) in a record for that entity within the entity table 1006. Such privacy settings may be applied to all types of relationships within the context of the digital interaction system 100 or may selectively be applied to certain types of relationships.

The profile data 1002 stores multiple types of profile data about a particular entity. The profile data 1002 may be selectively used and presented to other users of the digital interaction system 100 based on privacy settings specified by a particular entity. Where the entity is an individual, the profile data 1002 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 1002 for the group may similarly include one or more avatar representations associated with the group, in addition to the group name, members, and various settings (e.g., notifications) for the relevant group.

The database 128 also stores digital effect data, such as overlays or filters, in a digital effect table 1010. The digital effect data is associated with and applied to videos (for which data is stored in a video table 1012) and images (for which data is stored in an image table 1014).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 1014 includes augmented reality content items (e.g., corresponding to augmented reality experiences). An augmented reality content item may be a real-time special effect and sound that may be added to an image or a video.

A collections table 1016 stores data regarding collections of messages and associated image, video, or audio data, which are compiled into a collection (e.g., a narrative or a gallery). The creation of a particular collection may be initiated by a particular user (e.g., each user for which a record is maintained in the entity table 1006). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 1012 stores video data that, in some examples, is associated with messages for which records are maintained within the message table 1004. Similarly, the image table 1014 stores image data associated with messages for which message data is stored in the entity table 1006. The entity table 1006 may associate various digital effects from the digital effect table 1010 with various images and videos stored in the image table 1014 and the video table 1012.

### Data Communications Architecture

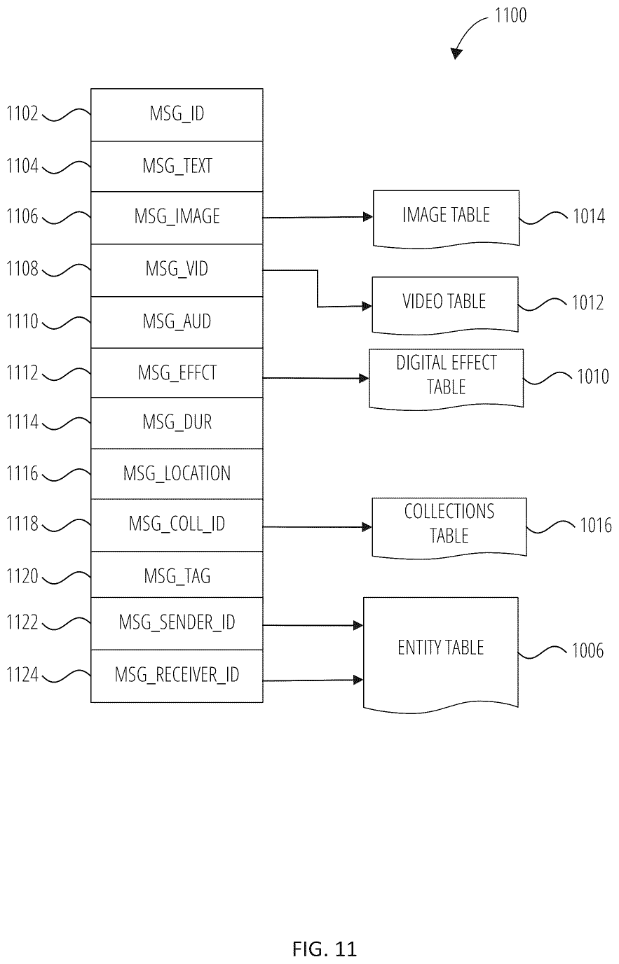

FIG. 11 is a schematic diagram illustrating a structure of a message 1100, according to some examples, generated by an interaction client 104 for communication to a further interaction client 104 via the servers 124. The content of a particular message 1100 is used to populate the message table 1004 stored within the database 128, accessible by the servers 124. Similarly, the content of a message 1100 is stored in memory as “in-transit” or “in-flight” data of the user system 102 or the servers 124. A message 1100 is shown to include the following example components:
Message identifier 1102: a unique identifier that identifies the message 1100.
Message text payload 1104: text, to be generated by a user via a user interface of the user system 102, and that is included in the message 1100.
Message image payload 1106: image data, captured by a camera component of a user system 102 or retrieved from a memory component of a user system 102, and that is included in the message 1100. Image data for a sent or received message 1100 may be stored in the image table 1014.
Message video payload 1108: video data, captured by a camera component or retrieved from a memory component of the user system 102, and that is included in the message 1100. Video data for a sent or received message 1100 may be stored in the video table 1012.
Message audio payload 1110: audio data, captured by a microphone or retrieved from a memory component of the user system 102, and that is included in the message 1100.
Message digital effect data 1112: digital effect data (e.g., filters, stickers, or other annotations or enhancements) that represents digital effects to be applied to message image payload 1106, message video payload 1108, or message audio payload 1110 of the message 1100. Digital effect data for a sent or received message 1100 may be stored in the digital effect table 1010.
Message duration parameter 1114: parameter value indicating, in seconds, the amount of time for which content of the message (e.g., the message image payload 1106, message video payload 1108, message audio payload 1110) is to be presented or made accessible to a user via the interaction client 104.
Message geolocation parameter 1116: geolocation data (e.g., latitudinal, and longitudinal coordinates) associated with the content payload of the message. Multiple message geolocation parameter 1116 values may be included in the payload, each of these parameter values being associated with respect to content items included in the content (e.g., a specific image within the message image payload 1106, or a specific video in the message video payload 1108).
Message collection identifier 1118: identifier values identifying one or more content collections (e.g., “stories” identified in the collections table 1016) with which a particular content item in the message image payload 1106 of the message 1100 is associated. For example, multiple images within the message image payload 1106 may each be associated with multiple content collections using identifier values.
Message tag 1120: each message 1100 may be tagged with multiple tags, each of which is indicative of the subject matter of content included in the message payload. For example, where a particular image included in the message image payload 1106 depicts an animal (e.g., a lion), a tag value may be included within the message tag 1120 that is indicative of the relevant animal. Tag values may be generated manually, based on user input, or may be automatically generated using, for example, image recognition.
Message sender identifier 1122: an identifier (e.g., a messaging system identifier, email address, or device identifier) indicative of a user of the user system 102 on which the message 1100 was generated and from which the message 1100 was sent.
Message receiver identifier 1124: an identifier (e.g., a messaging system identifier, email address, or device identifier) indicative of a user of the user system 102 to which the message 1100 is addressed.

The contents (e.g., values) of the various components of message 1100 may be pointers to locations in tables within which content data values are stored. For example, an image value in the message image payload 1106 may be a pointer to (or address of) a location within an image table 1014. Similarly, values within the message video payload 1108 may point to data stored within a video table 1012, values stored within the message digital effect data 1112 may point to data stored in a digital effect table 1010, values stored within the message collection identifier 1118 may point to data stored in a collections table 1016, and values stored within the message sender identifier 1122 and the message receiver identifier 1124 may point to user records stored within an entity table 1006.

### Machine Architecture

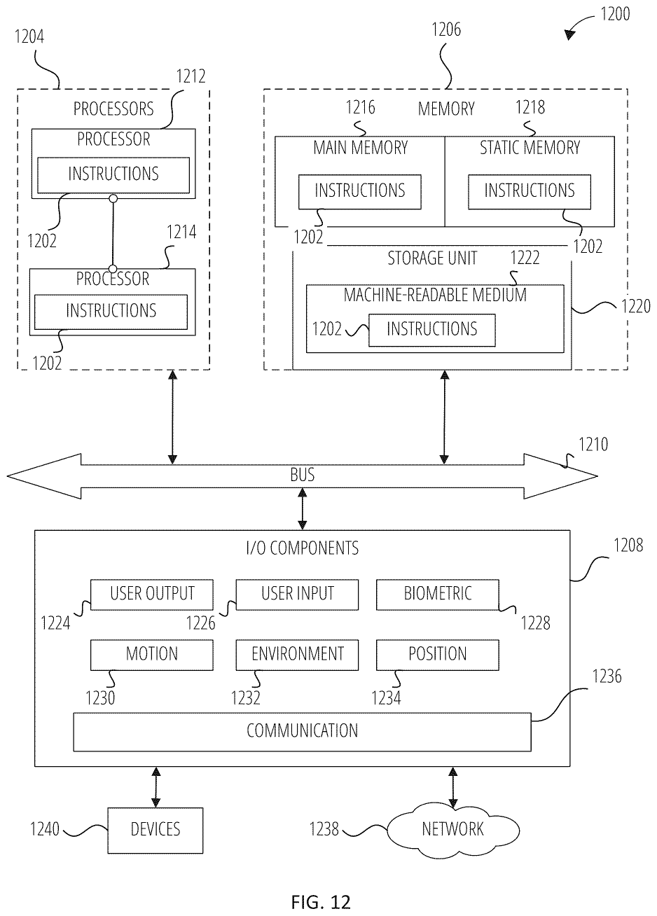

FIG. 12 is a diagrammatic representation of the machine 1200 within which instructions 1202 (e.g., software, a program, an application, an applet, an app, or other executable code) for causing the machine 1200 to perform any one or more of the methodologies discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. The machine 1200, for example, may comprise the user system 102 or any one of multiple server devices forming part of the server system 110. In some examples, the machine 1200 may also comprise both client and server systems, with certain operations of a particular method or algorithm being performed on the server-side and with certain operations of the method or algorithm being performed on the client-side.

The machine 1200 may include Processors 1204, memory 1206, and input/output I/O components 1208, which may be configured to communicate with each other via a bus 1210.

The memory 1206 includes a main memory 1216, a static memory 1218, and a storage unit 1220, both accessible to the Processors 1204 via the bus 1210. The main memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the Processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1224 and user input components 1226. The user output components 1224 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1230 include acceleration sensor components (e.g., accelerometer), gravitation sensor components, rotation sensor components (e.g., gyroscope).

The environmental components 1232 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1208 further include communication components 1236 operable to couple the machine 1200 to a Network 1238 or devices 1240 via respective coupling or connections. For example, the communication components 1236 may include a network interface component or another suitable device to interface with the Network 1238. In further examples, the communication components 1236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

The various memories (e.g., main memory 1216, static memory 1218, and memory of the Processors 1204) and storage unit 1220 may store one or more sets of instructions and data structures (e.g., software) embodying or used by any one or more of the methodologies or functions described herein. These instructions (e.g., the instructions 1202), when executed by Processors 1204, cause various operations to implement the disclosed examples.

The instructions 1202 may be transmitted or received over the Network 1238, using a transmission medium, via a network interface device (e.g., a network interface component included in the communication components 1236) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1240.

### Software Architecture

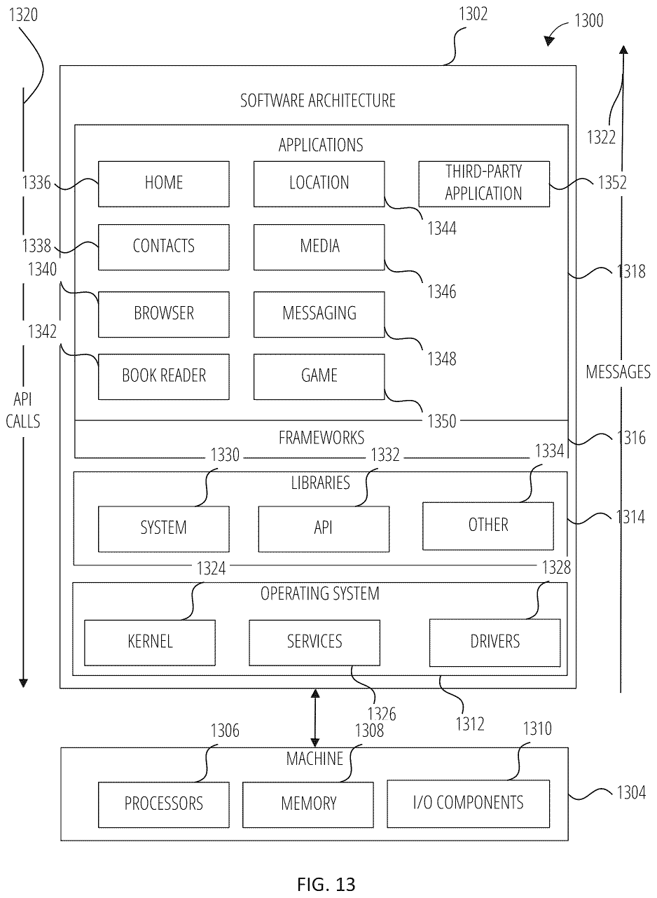

FIG. 13 is a block diagram 1300 illustrating a software architecture 1302, which can be installed on any one or more of the devices described herein. The software architecture 1302 is supported by hardware such as a machine 1304 that includes Processors 1306, memory 1308, and I/O components 1310. In this example, the software architecture 1302 can be conceptualized as a stack of layers, where each layer provides a particular functionality. The software architecture 1302 includes layers such as an operating system 1312, libraries 1314, frameworks 1316, and applications 1318. Operationally, the applications 1318 invoke API calls 1320 through the software stack and receive messages 1322 in response to the API calls 1320.

The operating system 1312 manages hardware resources and provides common services. The operating system 1312 includes, for example, a kernel 1324, services 1326, and drivers 1328. The kernel 1324 acts as an abstraction layer between the hardware and the other software layers. For example, the kernel 1324 provides memory management, processor management (e.g., scheduling), component management, networking, and security settings, among other functionalities. The services 1326 can provide other common services for the other software layers. The drivers 1328 are responsible for controlling or interfacing with the underlying hardware. For instance, the drivers 1328 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1314 provide a common low-level infrastructure used by the applications 1318. The libraries 1314 can include system libraries 1330 (e.g., C standard library) that provide functions such as memory allocation functions, string manipulation functions, mathematical functions, and the like. In addition, the libraries 1314 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1314 can also include a wide variety of other libraries 1334 to provide many other APIs to the applications 1318.

The frameworks 1316 provide a common high-level infrastructure that is used by the applications 1318. For example, the frameworks 1316 provide various graphical user interface (GUI) functions, high-level resource management, and high-level location services. The frameworks 1316 can provide a broad spectrum of other APIs that can be used by the applications 1318, some of which may be specific to a particular operating system or platform.

In an example, the applications 1318 may include a home application 1336, a contacts application 1338, a browser application 1340, a book reader application 1342, a location application 1344, a media application 1346, a messaging application 1348, a game application 1350, and a broad assortment of other applications such as a third-party application 1352. The applications 1318 are programs that execute functions defined in the programs. Various programming languages can be employed to create one or more of the applications 1318, structured in a variety of manners, such as object-oriented programming languages (e.g., Objective-C, Java, or C++) or procedural programming languages (e.g., C or assembly language). In a specific example, the third-party application 1352 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1352 can invoke the API calls 1320 provided by the operating system 1312 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number, respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1 is a system comprising: at least one processor; and at least one memory component storing instructions that, when executed by the at least one processor, cause the at least one processor to perform operations comprising: training a first machine learning model to generate a first output image based on an input image and a target image; training a second machine learning model to generate a second output image based on the input image and the target image, the training the second machine learning model comprising: minimizing a first loss function based on the first output image and the second output image; minimizing a second loss function based on the second output image and the target image; and minimizing a third loss function based on the second output image, the input image, and the target image; and generating a third output image using the second machine learning model.

In Example 2, the subject matter of Example 1 comprises generating a set of identity prompts describing attributes of a subject; generating a set of instruction prompts describing modifications; generating a set of target prompts based on the set of identity prompts and the set of instruction prompts; and generating a training data set comprising the input image and the target image based on the set of target prompts and the set of identity prompts.

In Example 3, the subject matter of Example 2 comprises wherein generating the training data set comprises: generating a set of target images comprising the target image based on the set of target prompts; and generating a set of input images comprising the input image based on the set of target images and the set of identity prompts.

In Example 4, the subject matter of Examples 1-3 comprises wherein training the first machine learning model comprises: minimizing a fourth loss function based on the input image and the first output image, the fourth loss function comprising a decreasing weight.

In Example 5, the subject matter of Example 4 comprises wherein training the first machine learning model further comprises: minimizing a fifth loss function based on the first output image and the target image, the fifth loss function comprising a comparison of predicted noise associated with the first output image with noise associated with the target image.

In Example 6, the subject matter of Examples 1-5 comprises wherein minimizing the first loss function comprises: training a discriminator model to distinguish between images generated by the second machine learning model and target images; and minimizing a difference between outputs of the discriminator model for the images generated by the second machine learning model.

In Example 7, the subject matter of Examples 1-6 comprises wherein minimizing the second loss function comprises: applying a sampling process to the second output image; and applying an inversion process to the second output image.

In Example 8, the subject matter of Examples 1-7 comprises wherein minimizing the third loss function comprises: generating an input image embedding based on the input image; generating an output image embedding based on the second output image; generating a target image embedding based on the target image; and minimizing a difference between a first distance and a second distance to within a margin parameter, the first distance being between the input image embedding and the output image embedding, the second distance being between the output image embedding and the target image embedding.

In Example 9, the subject matter of Examples 1-8 comprises wherein generating the third output image is based on an input instruction.

In Example 10, the subject matter of Example 9 comprises generating a fourth output image using the second machine learning model based on the third output image and the input instruction.

Example 11 is a computer-implemented method comprising: training a first machine learning model to generate a first output image based on an input image and a target image; training a second machine learning model to generate a second output image based on the input image and the target image, the training the second machine learning model comprising: minimizing a first loss function based on the first output image and the second output image; minimizing a second loss function based on the second output image and the target image; and minimizing a third loss function based on the second output image, the input image, and the target image; and generating a third output image using the second machine learning model.

In Example 12, the subject matter of Example 11 comprises generating a set of identity prompts describing attributes of a subject; generating a set of instruction prompts describing modifications; generating a set of target prompts based on the set of identity prompts and the set of instruction prompts; and generating a training data set comprising the input image and the target image based on the set of target prompts and the set of identity prompts.

In Example 13, the subject matter of Example 12 comprises wherein generating the training data set comprises: generating a set of target images comprising the target image based on the set of target prompts; and generating a set of input images comprising the input image based on the set of target images and the set of identity prompts.

In Example 14, the subject matter of Examples 11-13 comprises wherein training the first machine learning model comprises: minimizing a fourth loss function based on the input image and the first output image, the fourth loss function comprising a decreasing weight.

In Example 15, the subject matter of Example 14 comprises wherein training the first machine learning model further comprises: minimizing a fifth loss function based on the first output image and the target image, the fifth loss function comprising a comparison of predicted noise associated with the first output image with noise associated with the target image.

In Example 16, the subject matter of Examples 11-15 comprises wherein minimizing the first loss function comprises: training a discriminator model to distinguish between images generated by the second machine learning model and target images; and minimizing a difference between outputs of the discriminator model for the images generated by the second machine learning model.

In Example 17, the subject matter of Examples 11-16 comprises wherein minimizing the second loss function comprises: applying a sampling process to the second output image; and applying an inversion process to the second output image.

In Example 18, the subject matter of Examples 11-17 comprises wherein minimizing the third loss function comprises: generating an input image embedding based on the input image; generating an output image embedding based on the second output image; generating a target image embedding based on the target image; and minimizing a difference between a first distance and a second distance to within a margin parameter, the first distance being between the input image embedding and the output image embedding, the second distance being between the output image embedding and the target image embedding.

In Example 19, the subject matter of Examples 11-18 comprises wherein generating the third output image is based on an input instruction, the computer-implemented method further comprising: generating a fourth output image using the second machine learning model based on the third output image and the input instruction.

Example 20 is a non-transitory computer-readable storage medium storing instructions that, when executed by at least one processor, cause the at least one processor to perform operations comprising: training a first machine learning model to generate a first output image based on an input image and a target image; training a second machine learning model to generate a second output image based on the input image and the target image, the training the second machine learning model comprising: minimizing a first loss function based on the first output image and the second output image; minimizing a second loss function based on the second output image and the target image; and minimizing a third loss function based on the second output image, the input image, and the target image; and generating a third output image using the second machine learning model.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Arca Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled, or owned by a user and with which the user interacts perform an action, engagement, or interaction on the user device, including an interaction with other users or computer systems.

What is claimed is:

1. A system comprising:
at least one processor; and
at least one memory component storing instructions that, when executed by the at least one processor, cause the at least one processor to perform operations comprising:
training a first machine learning model to generate a first output image based on an input image and a target image;
training a second machine learning model to generate a second output image based on the input image and the target image, the training the second machine learning model comprising:
minimizing a first loss function based on the first output image and the second output image;
minimizing a second loss function based on the second output image and the target image; and
minimizing a third loss function based on the second output image, the input image, and the target image; and
generating a third output image using the second machine learning model.

2. The system of claim 1, the operations further comprising:
generating a set of identity prompts describing attributes of a subject;
generating a set of instruction prompts describing modifications;
generating a set of target prompts based on the set of identity prompts and the set of instruction prompts; and
generating a training data set comprising the input image and the target image based on the set of target prompts and the set of identity prompts.

3. The system of claim 2, wherein generating the training data set comprises:
generating a set of target images comprising the target image based on the set of target prompts; and
generating a set of input images comprising the input image based on the set of target images and the set of identity prompts.

4. The system of claim 1, wherein training the first machine learning model comprises:
minimizing a fourth loss function based on the input image and the first output image, the fourth loss function comprising a decreasing weight.

5. The system of claim 4, wherein training the first machine learning model further comprises:
minimizing a fifth loss function based on the first output image and the target image, the fifth loss function comprising a comparison of predicted noise associated with the first output image with noise associated with the target image.

6. The system of claim 1, wherein minimizing the first loss function comprises:
training a discriminator model to distinguish between images generated by the second machine learning model and target images; and
minimizing a difference between outputs of the discriminator model for the images generated by the second machine learning model.

7. The system of claim 1, wherein minimizing the second loss function comprises:
applying a sampling process to the second output image; and
applying an inversion process to the second output image.

8. The system of claim 1, wherein minimizing the third loss function comprises:
generating an input image embedding based on the input image;
generating an output image embedding based on the second output image;
generating a target image embedding based on the target image; and
minimizing a difference between a first distance and a second distance to within a margin parameter, the first distance being between the input image embedding and the output image embedding, the second distance being between the output image embedding and the target image embedding.

9. The system of claim 1, wherein generating the third output image is based on an input instruction.

10. The system of claim 9, the operations further comprising:
generating a fourth output image using the second machine learning model based on the third output image and the input instruction.

11. A computer-implemented method comprising:
training a first machine learning model to generate a first output image based on an input image and a target image;
training a second machine learning model to generate a second output image based on the input image and the target image, the training the second machine learning model comprising:
minimizing a first loss function based on the first output image and the second output image;
minimizing a second loss function based on the second output image and the target image; and
minimizing a third loss function based on the second output image, the input image, and the target image; and
generating a third output image using the second machine learning model.

12. The computer-implemented method of claim 11, further comprising:
generating a set of identity prompts describing attributes of a subject;
generating a set of instruction prompts describing modifications;
generating a set of target prompts based on the set of identity prompts and the set of instruction prompts; and
generating a training data set comprising the input image and the target image based on the set of target prompts and the set of identity prompts.

13. The computer-implemented method of claim 12, wherein generating the training data set comprises:
generating a set of target images comprising the target image based on the set of target prompts; and
generating a set of input images comprising the input image based on the set of target images and the set of identity prompts.

14. The computer-implemented method of claim 11, wherein training the first machine learning model comprises:
minimizing a fourth loss function based on the input image and the first output image, the fourth loss function comprising a decreasing weight.

15. The computer-implemented method of claim 14, wherein training the first machine learning model further comprises:
minimizing a fifth loss function based on the first output image and the target image, the fifth loss function comprising a comparison of predicted noise associated with the first output image with noise associated with the target image.

16. The computer-implemented method of claim 11, wherein minimizing the first loss function comprises:
training a discriminator model to distinguish between images generated by the second machine learning model and target images; and
minimizing a difference between outputs of the discriminator model for the images generated by the second machine learning model.

17. The computer-implemented method of claim 11, wherein minimizing the second loss function comprises:
applying a sampling process to the second output image; and
applying an inversion process to the second output image.

18. The computer-implemented method of claim 11, wherein minimizing the third loss function comprises:
generating an input image embedding based on the input image;
generating an output image embedding based on the second output image;
generating a target image embedding based on the target image; and
minimizing a difference between a first distance and a second distance to within a margin parameter, the first distance being between the input image embedding and the output image embedding, the second distance being between the output image embedding and the target image embedding.

19. The computer-implemented method of claim 11, wherein generating the third output image is based on an input instruction, the computer-implemented method further comprising:
generating a fourth output image using the second machine learning model based on the third output image and the input instruction.

20. A non-transitory computer-readable storage medium storing instructions that, when executed by at least one processor, cause the at least one processor to perform operations comprising:
training a first machine learning model to generate a first output image based on an input image and a target image;
training a second machine learning model to generate a second output image based on the input image and the target image, the training the second machine learning model comprising:
minimizing a first loss function based on the first output image and the second output image;
minimizing a second loss function based on the second output image and the target image; and
minimizing a third loss function based on the second output image, the input image, and the target image; and
generating a third output image using the second machine learning model.
